(19) United States
(12) Patent Application Publication
(10) Pub. No.: US 2025/0207823 A1
(43) Pub. Date: Jun. 26, 2025

(54) METHOD OF SELECTING PIPING MATERIAL AND GEOTHERMAL POWER PLANT

(71) Applicant: FUJI ELECTRIC CO., LTD., Kanagawa (JP)

(72) Inventors: Yukari SHIBUTA, Tokyo (JP); Tianlong JIANG, Tokyo (JP)

(21) Appl. No.: 19/039,197

(22) Filed: Jan. 28, 2025

Related U.S. Application Data
(63) Continuation of application No. PCT/JP2024/000473, filed on Jan. 11, 2024.

(30) Foreign Application Priority Data
Feb. 16, 2023 (JP) 2023-022944

(51) Int. Cl. F24T 50/00; C08L 23/0892; C08L 27/06; C08L 33/12; C08L 77/02; F16L 58/00

(52) U.S. Cl. CPC F24T 50/00; C08L 23/0892; C08L 27/06; C08L 33/12; C08L 77/02; F16L 58/00; C08L 2203/18

(57) ABSTRACT

A method of selecting a piping material is provided for selecting a piping material to be used for piping through which a geothermal fluid containing a monomer or a dimeter to tetramer of orthosilicic acid is passed in a geothermal power plant. The method includes predicting adhesiveness of two or more types resin materials having different compositions or chemical structures to a monomer or a dimeter to tetramer of orthosilicic acid by comparing the molecular orbital energy levels of the resin materials, and selecting a resin material selected based on the adhesiveness as a piping material for reducing adhesion of silica scale precipitated from the geothermal fluid.

### CROSS-REFERENCE TO RELATED APPLICATIONS

This application is a continuation application of International Application No. PCT/JP2024/000473, filed on Jan. 11, 2024, and designating the U.S., which is based upon and claims priority to Japanese Patent Application No. 2023-022944, filed on Feb. 16, 2023, the entire contents of which are incorporated herein by reference.

### BACKGROUND

### Technical Field

The present invention relates to a method of selecting a piping material and relates to a geothermal power plant.

### Background Art

In geothermal power generation, high-temperature geothermal fluid (geothermal water and geothermal steam) is collected from a production well and power generation is performed utilizing steam separated from the geothermal fluid. The geothermal fluid collected from the production well contains more dissolved silica than does well water or river water.

In a geothermal power plant, dissolved silica in geothermal water collected from a production well is concentrated by depressurization, and is cooled while flowing through piping, resulting in reduction in the solubility. Then, when silica contained in the geothermal water becomes supersaturated, it polymerizes to form amorphous silica and precipitates as silica scale. Because silica scale adheres to the inner wall of piping and the like and may cause clogging of the piping and the like, adhesion of silica scale is a problem in geothermal power plants.

Conventionally, piping for reducing adhesion of silica scale has been studied. For example, Japanese Patent Application Laid-Open Publication No. 2017-155302 discloses a coating for the inner surface of metal piping for water, wherein the coating is made of a coating having a thickness of 100 nm or greater and 1,000 nm or less, and containing 80% by volume or greater and 95% by volume or less of silica, and organic materials and pores as the balance.

### SUMMARY

However, the coating for the inner surface of metal piping for water described in Japanese Patent Application Laid-Open Publication No. 2017-155302 may allow geothermal fluid to permeate the metal piping for water, which is the base material, through the pores in the coating, potentially corroding the metal piping for water. Therefore, application of a resin material as a piping material has been studied. Generally, when selecting a resin material having a low adhesiveness to silica scale, experimental and empirical methods are used. Therefore, problems arise counter to expectation, and considerable time and energy is spent on the selection of a resin material.

An embodiment of the present invention provides a method of selecting a piping material, which can select a suitable resin material as a piping material for reducing adhesion of silica scale in a geothermal power plant.

An embodiment of the present invention is a method of selecting a piping material to be used for piping through which a geothermal fluid containing a monomer or a dimer to tetramer of orthosilicic acid is passed in a geothermal power plant. The method includes: predicting adhesiveness of two or more types resin materials having different compositions or chemical structures to the monomer or the dimer to tetramer of orthosilicic acid by comparing molecular orbital energy levels of the resin materials, and selecting a resin material selected based on the adhesiveness as a piping material for reducing adhesion of silica scale precipitated from the geothermal fluid.

According to a method of selecting a piping material according to an embodiment of the present invention, a suitable resin material can be selected as a piping material for reducing adhesion of silica scale in a geothermal power plant.

### BRIEF DESCRIPTION OF THE DRAWINGS

FIG. 1 is a flowchart illustrating an example of a method for calculating molecular orbital energy levels;

FIG. 2 is a schematic diagram of a geothermal power plant according to an embodiment;

FIG. 3 is a graph illustrating a calculated Lowest Unoccupied Molecular Orbital (LUMO) energy of each resin material; and

FIG. 4 is a SEM image illustrating a surface of a material piece made of PVC.

### DETAILED DESCRIPTION OF THE INVENTION

Hereinafter, an embodiment for carrying out the present invention will be described with reference to the drawings.

The method of selecting a piping material according to the present embodiment is a method of selecting a piping material to be used for piping through which a geothermal fluid containing a monomer or a dimer to tetramer of orthosilicic acid is passed in a geothermal power plant. In a geothermal power plant, the concentration of dissolved silica in a geothermal fluid passed through the piping reaches 450 parts per million (ppm) to 900 ppm. In the geothermal fluid, a monomer of dissolved orthosilicic acid present at a high concentration undergoes dehydration condensation to form a dimer, which grows through further dehydration condensation and precipitates as silica scale. In addition, since a monomer or a dimer to tetramer of orthosilicic acid have a particularly high reactivity, they easily bond with molecules on the inner circumferential surface of the piping, that is, they easily adhere to the inner circumferential surface of the piping, and it is presumed that they largely affect the adhesion of silica scale.

The method of selecting a piping material according to the present embodiment predicts the adhesiveness of two or more types of resin materials having different compositions or chemical structures to a monomer or a dimeter to a tetramer of orthosilicic acid by comparing the molecular orbital energy levels of the resin materials. Then, the resin material selected based on the adhesiveness is selected as a piping material for reducing adhesion of silica scale precipitated from a geothermal fluid. Thus, the adhesiveness of the plurality of candidate resin materials to the monomer or the dimeter to the tetramer of orthosilicic acid can be predicted, and a suitable resin material can be selected as a piping material for reducing adhesion of silica scale in a geothermal power plant. That is, by using the resin material selected by the method of selecting a piping material according to the present embodiment as a piping material, it is possible to reduce adhesion of silica scale to the inner circumferential surface of the piping. Further, by using the resin material selected by the method of selecting a piping material according to the present embodiment as a piping material, it is possible to inhibit corrosion by a geothermal fluid as compared with a case where a metal material is used as a piping material, and to facilitate installation, replacement, and the like of the piping.

Specific examples of two or more types of resin materials having different chemical structures include two or more types of resin materials that are structural isomers or stereoisomers. The molecular orbital energy levels of two or more types of resin materials having different compositions or chemical structures can be obtained by the first-principles calculation. The first-principles calculation can be executed, for example, by commercially available calculation software, such as Gaussian (registered trademark).

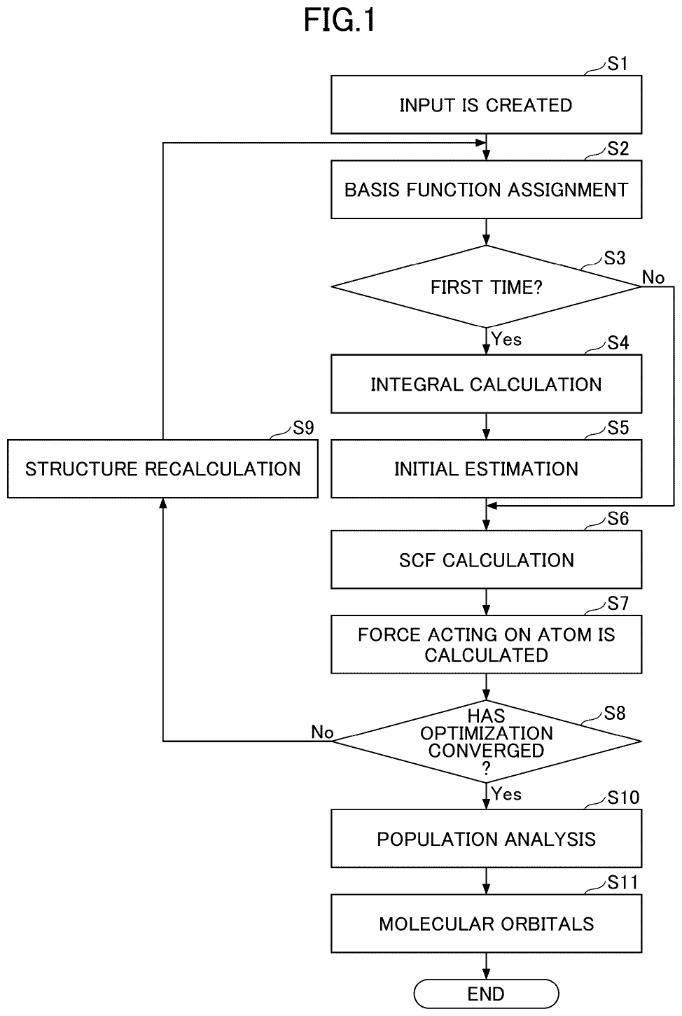

FIG. 1 is a flowchart illustrating an example of a method of calculating the molecular orbital energy levels. As a method of obtaining the molecular orbital energy levels by the first-principles calculation, specifically, for example, a type of calculation, a calculation method, conditions related to initial orbital estimation, conditions related to electron density analysis and molecular orbital output, and the like are set. Then, as illustrated in FIG. 1, a molecular model of a molecule constituting a candidate resin material is created and input (step S1), and a basis function is assigned (step S2). Next, it is determined whether or not the assignment of a basis function is the first time (step 3), and in a case where it is determined that the assignment is the first time (step S3: Yes), an integral calculation is performed (step S4). An initial estimation of a molecular orbital is performed based on the result of the integral calculation (step S5), a Self-Consistent Field calculation (SCF) is performed (step S6), and then a force acting on the atom is calculated (step S7). Next, it is determined whether or not the calculation for structural optimization has converged (step S8), and in a case where it is determined that it has not converged (step S8: No), the calculation for structural optimization is performed again (step S9), and the flow returns to step 2 to assign a basis function again. Next, in a case where it is determined in step 3 that the assignment of a basis function is not the first time (step S3: No), the flow proceeds to step 6, and then to step 7. Thereafter, in a case where it is determined in step 8 that the calculation for structural optimization has not converged (step S8: No), the calculation for structural optimization is performed again (step S9), and steps 2, 3, and 6 to 9 are repeated until the calculation for structural optimization has converged. In a case where it is determined in step 8 that the calculation for structural optimization has converged (step S8: Yes), electron density analysis (population analysis) is performed (step S10), and information on molecular orbitals is output based on the analysis results (step S11), and the flow ends.

Although FIG. 1 illustrates a calculation method using the molecular orbital method as the first-principles calculation, the calculation method is not limited to this, and any calculation method such as density functional method (DFT), coupled cluster method (CCSD, etc.), Hartree-Fock method (HF), or the like can be used as the first-principles calculation.

The molecular orbital energy level used in the method of selecting a piping material according to the present embodiment may be the Lowest Unoccupied Molecular Orbital (LUMO) energy level. Since a monomer or a dimer to tetramer of orthosilicic acid (silica) is an electron donor, it is considered that the electrons of the monomer or the dimer to tetramer of orthosilicic acid migrate to the LUMO of a resin material, thereby chemically bonding with the molecules constituting the resin material and adhering to the surface of the resin material. Here, the lower the LUMO energy level of the resin material, the more easily the electrons of the monomer or the dimer to tetramer of orthosilicic acid migrate to the LUMO of the resin material, and the more easily the energy is stabilized after the migration. As a result, it is considered that the lower the LUMO energy level of the resin material, the more easily the monomer or the dimer to tetramer of orthosilicic acid is adhered to the surface of the resin material. From the foregoing, it is possible to predict the adhesiveness of a plurality of candidate resin materials to the monomer or the dimer to tetramer of orthosilicic acid by comparing the LUMO energy levels of the resin materials. Therefore, the method of selecting a piping material according to the present embodiment can select a resin material suitable as a piping material for reducing adhesion of silica scale in a geothermal power plant.

According to the method of selecting a piping material according to the present embodiment, it is preferable to select a resin material having a LUMO energy level higher than the LUMO energy level of polytetrafluoroethylene (PTFE). In general, among resin materials, PTFE is known to have a low adhesiveness to many substances. As a result of careful study, the inventor obtained knowledge that PTFE has a high adhesiveness to silica scale. In the method of selecting a piping material according to the present embodiment, by selecting a resin material having a LUMO energy level higher than the LUMO energy level of PTFE, it is possible to select a resin material more suitable as a piping material for reducing adhesion of silica scale in a geothermal power plant.

Specifically, the method of selecting a piping material according to the present embodiment may select a resin material having a LUMO energy level higher than 3.5 electron volt (eV), which is the LUMO energy level of PTFE.

Further, according to the method of selecting a piping material according to the present embodiment, it is more preferable to select a resin material having the highest LUMO energy level among two or more types of resin materials having a LUMO energy level higher than the LUMO energy level of polytetrafluoroethylene. Thus, it is possible to select a resin material more suitable as a piping material for reducing adhesion of silica scale in a geothermal power plant.

The method of selecting a piping material according to the present embodiment may select a resin material having a LUMO energy level higher than the LUMO energy level of PTFE and having an energy difference of 0.5 eV or more from the LUMO energy level of PTFE. Thus, it is possible to select a resin material more suitable as a piping material for reducing adhesion of silica scale in a geothermal power plant.

Specifically, the method of selecting a piping material according to the present embodiment may select a resin material having a LUMO energy level of 4.0 eV or more since the LUMO energy level of PTFE is 3.5 eV.

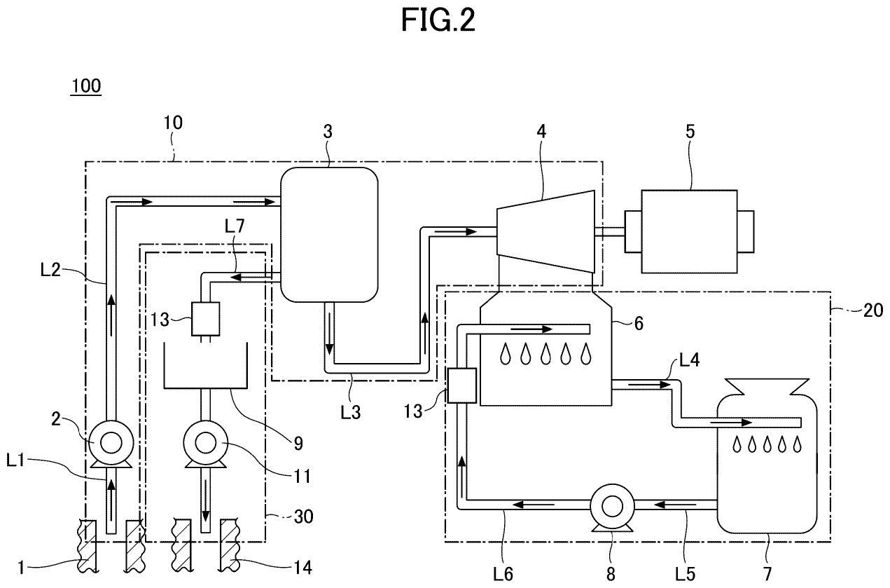

FIG. 2 is a schematic configuration diagram of a geothermal power plant according to an embodiment. A geothermal power plant 100 according to the present embodiment includes piping that contains a resin material selected by the method of selecting a piping material described above at least in an inner circumferential surface of the piping. The method of selecting a piping material according to the present embodiment can select a suitable resin material as a piping material for reducing adhesion of silica scale in the geothermal power plant. Therefore, the geothermal power plant according to the present embodiment can reduce adhesion of silica scale to the inner circumferential surface of the piping.

The geothermal power plant 100 according to the present embodiment preferably includes piping made of a resin material selected by the method of selecting a piping material described above. In general, in piping provided with a coating layer on the inner circumferential surface thereof, the coating layer may peel, and the bonding force between the inner circumferential surface of the piping and silica scale may increase. In the geothermal power plant 100 according to the present embodiment, since the entire piping is made of the selected resin material, even when the inner circumferential surface of the piping peels or is damaged, the bonding force between the inner circumferential surface of the piping and silica scale can be suppressed. Therefore, in the geothermal power plant 100 according to the present embodiment, adhesion of silica scale to the inner circumferential surface of the piping can be further reduced.

An example of the configuration of the geothermal power plant 100 will be described with reference to FIG. 2. The geothermal power plant 100 may include a water supply pump 2 configured to pump geothermal fluid from a production well 1, a gas-water separator 3 configured to separate the geothermal fluid into geothermal water and geothermal steam, and a turbine 4 configured to rotate by being supplied with the geothermal steam separated by the gas-water separator 3, which are situated in an order from the upstream side of the geothermal fluid. In the geothermal power plant 100, the above-described region extending from the production well 1 to the turbine 4 can be a first region 10. That is, the first region 10 includes the production well 1, the water supply pump 2, the gas-water separator 3, and the turbine 4. The turbine 4 is connected to a power generator 5. The first region is a region in the geothermal power plant 100 that is in a high-temperature high-pressure environment.

The geothermal power plant 100 may include a pipe L1 for introducing geothermal fluid (geothermal water and geothermal steam) pumped from the production well 1 into the water supply pump 2, a pipe L2 for introducing the geothermal fluid discharged from the water supply pump 2 into the gas-water separator 3, and a pipe L3 for introducing the geothermal steam separated by the gas-water separator 3 into the turbine 4. That is, the first region 10 may include the pipes L1 to L3.

The geothermal power plant 100 may include a condenser 6 for condensing the geothermal steam discharged from the turbine 4, a cooling tower 7 for cooling condensed water condensed by the condenser 6, and a circulation pump 8 for sending cooling water cooled by the cooling tower 7 to the condenser 6. In the geothermal power plant 100, a region from the condenser 6 to the condenser 6 to which condensed water is returned while being cooled may be a second region 20. That is, the second region 20 may include the condenser 6, the cooling tower 7, and the circulation pump 8. The second region is a region in the geothermal power plant 100 that is in a low-temperature low-pressure environment.

The geothermal power plant 100 may include a pipe L4 for introducing condensed water (hot water) condensed by the condenser 6 into the cooling tower 7, a pipe L5 for introducing the cooling water cooled by the cooling tower 7 into the circulation pump 8, and a pipe L6 for returning the cooling water discharged from the circulation pump 8 to the condenser 6. That is, the second region 20 may include the pipes L4 to L6.

The geothermal power plant 100 may include a retention tank 9 situated on a flow path through which geothermal water separated by the gas-water separator 3 flows, and a reduction pump 11 for returning the geothermal water discharged from the retention tank 9 to a reduction well 14. The retention tank 9 promotes polymerization reaction of silica in the geothermal water, and retains the geothermal water until silica-based insoluble component sufficiently flocculates and precipitates. In the geothermal power plant 100, a region extending from the outlet of the gas-water separator 3 from which the geothermal water flows out to the reduction well 14 can be a third region 30. That is, the third region 30 may include the retention tank 9, the reduction pump 11, and the reduction well 14. The third region is a region in the geothermal power plant 100 that is in a high-temperature medium-pressure or medium-temperature high-pressure environment.

The geothermal power plant 100 may include a pipe L7 for introducing geothermal water separated by the gas-water separator 3 into the retention tank 9. That is, the third region 30 may include the pipe L7.

The geothermal power plant 100 may include a collector 13 connected to the pipe L7 constituting the flow path between the gas-water separator 3 and the retention tank 9. The collector 13 may be, for example, a container having a wire mesh inside for capturing scale fragments or a container having the same function as the retention tank 9. The geothermal power plant 100 may further include another collector 13 connected to the pipe L6 constituting a flow path between the circulation pump 8 and the condenser 6.

Next, the flow of geothermal fluid in the geothermal power plant 100 will be described. In FIG. 2, the flow of geothermal fluids is indicated by solid arrows in each pipe. The production well 1 is a well that draws geothermal water, geothermal steam, or a mixture of these (geothermal fluid) from an underground geothermal reservoir to the ground. The geothermal fluid pumped from the production well 1 is introduced into the water supply pump 2 through the pipe L1 and sent to the gas-water separator 3 through the pipe L2. The gas-water separator 3 separates geothermal steam as a gaseous component and geothermal water as a liquid component. The separated geothermal steam is sent to the turbine 4 through the pipe L3 and used to rotate the turbine 4 for power generation by the power generator 5.

The geothermal steam that has passed through the turbine 4 is sent to the condenser 6 to be condensed, and condensed water resulting from the condensation is further sent to the cooling tower 7 through the pipe L4 to be cooled. The cooled cooling water is introduced into the circulation pump 8 through the pipe L5, returned to the condenser 6 through the pipe L6, and used as cooling water for the geothermal steam that has passed the turbine 4.

The geothermal power plant 100 may have piping containing a resin material selected by the above-described method of selecting a piping material at least in the inner circumferential surface of the piping in at least the first region 10 and the second region 20. This makes it possible to reduce adhesion of silica scale to the inner circumferential surface of the piping in regions where silica scale is likely to occur, and makes it possible to more effectively reduce adhesion of silica scale in the geothermal power plant 100 as a whole.

The method of selecting a piping material according to the present embodiment can be applied not only to a geothermal power plant having the configuration illustrated in FIG. 2, but also to a geothermal power plant having any configuration. In other words, the geothermal power plant 100 of the present embodiment is not limited to the configuration illustrated in FIG. 2, but may be any geothermal power plant. The geothermal power plant 100 may be, for example, a binary cycle type geothermal power plant.

### EXAMPLES

Next, Examples of the present invention will be described.

Trimer to pentamer molecular models were created for nine types of resin materials including: polytetrafluoroethylene (PTFE); polyvinyl chloride (PVC); ethylenetetrafluoroethylene (ETFE); isotactic polymethylmethacrylate (it-PMMA); syndiotactic polymethylmethacrylate (st-PMMA); polyethylene terephthalate-1 (PET-1); polyethylene terephthalate-2 (PET-2); nylon 6 (nylon 6); and polybutylene terephthalate (PBT), and their molecular orbital energy levels were calculated by the first-principles calculation. Then, the LUMO energy among the molecular orbital energy levels was extracted. PET-1 was constructed as a molecular model (cis conformation) in which two carbonyl groups derived from terephthalic acid were positioned on the same side, and PET-2 was constructed as a molecular model (trans conformation) in which two carbonyl groups derived from terephthalic acid were positioned on opposite sides to each other. PBT was constructed as a molecular model (trans conformation) in which two carbonyl groups derived from terephthalic acid were positioned on opposite sides to each other.

Molecular orbital energy levels were calculated by Gaussian (registered trademark) using the calculation method illustrated in FIG. 1. As calculation conditions, structural optimization was set as the calculation type, the second-order perturbation theory (MP2) was set as the calculation method, the extended Huckel method was set as the condition related to initial orbital estimation, and a normal mode was set as the condition related to electron density analysis and molecular orbital output.

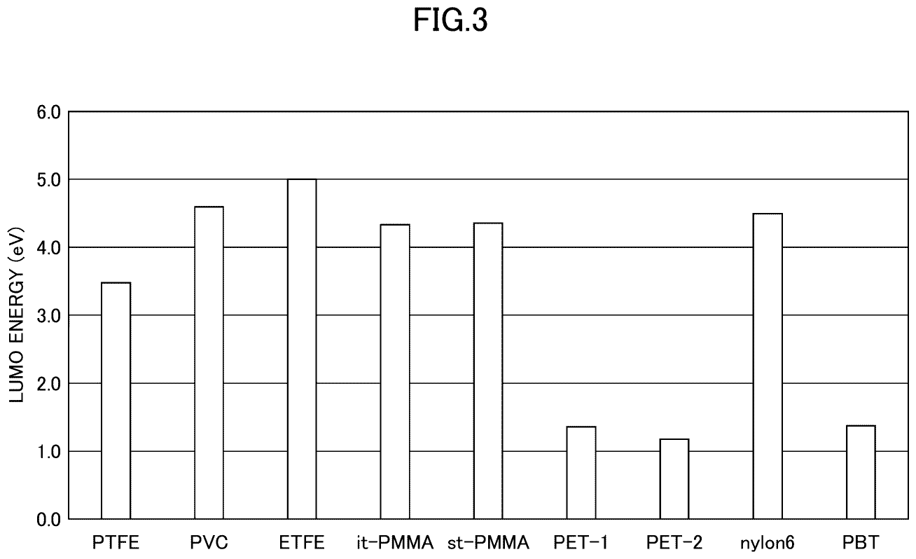

FIG. 3 is a graph illustrating the calculated LUMO energies of the respective resin materials. The calculated LUMO energies of the respective resin materials illustrated in FIG. 3 were compared, and ETFE, PVC, nylon 6, it-PMMA, and st-PMMA were selected from the nine types of resin materials based on the prediction that resin materials having LUMO energy levels higher than the LUMO energy level of PTFE were resin materials having a low adhesiveness to the monomer or the dimer to tetramer of orthosilicic acid.

Among the selected resin materials, a material piece made of PVC was installed in the retention tank of the geothermal power plant, removed after 107 days passed, and subjected to ultrasonic cleaning, and the surface of the material piece was observed using a Scanning Electron Microscope (SEM) at a magnification of ×1,000.

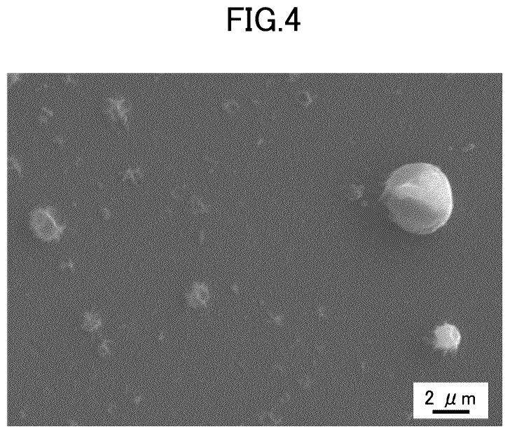

FIG. 4 is an SEM observation image illustrating the surface of the material piece made of PVC. As illustrated in FIG. 4, it was confirmed that the amount of silica scale adhesion on the surface of the material piece made of PVC was low.

Although the embodiments have been described above, the above embodiments are presented as examples, and the present invention is not limited by the above embodiments. The above embodiments can be carried out in various other forms, and various combinations, omissions, substitutions, modifications, and the like are applicable without departing from the spirit of the invention. These embodiments and modifications thereof are included in the scope and spirit of the invention, and are included in the scope of the invention described in the claims and equivalents thereof.

What is claimed is:

1. A method of selecting a piping material to be used for piping through which a geothermal fluid containing a monomer or a dimer to tetramer of orthosilicic acid is passed in a geothermal power plant, the method comprising:
predicting adhesiveness of two or more types of resin materials having different compositions or chemical structures to the monomer or the dimer to tetramer of orthosilicic acid by comparing molecular orbital energy levels of the resin materials; and
selecting a resin material selected based on the adhesiveness as a piping material for reducing adhesion of silica scale precipitated from the geothermal fluid.

2. The method of selecting a piping material according to claim 1, further comprising:
obtaining the molecular orbital energy levels by first-principles calculation.

3. The method of selecting a piping material according to claim 2,
wherein the molecular orbital energy levels are lowest unoccupied molecular orbital energy levels.

4. The method of selecting a piping material according to claim 3, further comprising:
selecting a resin material having the lowest unoccupied molecular orbital energy level higher than the lowest unoccupied molecular orbital energy level of polytetrafluoroethylene.

5. The method of selecting a piping material according to claim 4, further comprising:
selecting a resin material having the lowest unoccupied molecular orbital energy level that is highest of the two or more types of resin materials that have the lowest unoccupied molecular orbital energy levels higher than the lowest unoccupied molecular orbital energy level of polytetrafluoroethylene.

6. A geothermal power plant, comprising:
piping containing a resin material at least in an inner circumferential surface of the piping, the resin material being selected by the method of selecting a piping material of claim 1.
